(19) United States
(12) Patent Application Publication
(10) Pub. No.: US 2009/0139047 A1
(43) Pub. Date: Jun. 4, 2009

(54) Power tool dust-collecting assembly

(76) Inventor: Danny P. Williams, Temecula, CA (US)

Correspondence Address: Mr. Loyal M. Hanson;Hanson Law Corporation, P.O. Box 430, Fallbrook, CA, 92088-0430, US

(21) Appl. No.: 11/998,490

(22) Filed: Nov. 30, 2007

(51) Int. Cl. A47L 9/00; A47L 5/00; B08B 5/04

(52) U.S. Cl. 15/347; 15/300.1; 15/301

(57) ABSTRACT

A power tool dust-collecting assembly for collecting dust from a dust port of a power tool includes an airflow-producing subassembly for sucking sawdust and/or other dust from the dust port. A coupling component is provided for coupling an air-and-dust input port of the airflow-producing subassembly to the dust port of the power tool, and a bag subassembly is included for collecting dust from a dust output port of the airflow-producing subassembly. Those parts form a motorized dust bag that is adapted to be physically supported by the dust port of the power tool without requiring other support. One embodiment includes a secondary input portion of the coupling component for capturing dust from beneath the power tool.

### BACKGROUND OF THE INVENTION

1. Technical Field

This invention relates generally to the fields of woodworking and power tools, including power saws, power sanders, and the like. It relates more particularly to a dust-collecting assembly for collecting sawdust and/or other dust produced and/or expelled by such a tool.

2. Description of Related Art

Health, hygiene, and work-site cleanup issues make the production of sawdust and/or other dust by a power tool a major concern. Many dust-collecting techniques and devices have been invented as a result. Some current dust-collecting designs for chop saws, miter saws, and the like, for example, include a one-inch diameter dust outlet port on the tool (i.e., a dust port or dust duct) through which sawdust is expelled. An air flow produced by operation of the tool carries dust through the dust port and into a dust-collecting bag attached to the dust port.

Although such a dust-bag arrangement proves useful in some respects, it relies only on the tool-produced airflow. As a result, users often desire to enhance the movement of dust through the dust port. They do so at times by attaching an available shop-vac (i.e., a workshop vacuum cleaner device that is frequently designed for heavy duty use in cleaning up wet and/or dry material) to the dust port via a length of ordinary shop-vac hose. The shop-vac produces an airflow resulting in a vigorous sucking action that draws sawdust through the dust port more effectively.

Using a shop-vac connected to the dust port in the manner described introduces some concerns, however. First, a typical shop-vac is somewhat large and bulky, and connecting it to the dust port involves some time and inconvenience. In addition, the use of multiple dust-producing power tools means multiple shop-vacs, or disconnection from one tool and connection to another tool as needed, or the extra task of obtaining and connecting a manifold for multiple shop-vac hoses. Furthermore, the electric power required by a shop-vac can be significant for such a use, and the use of multiple shop-vacs only compounds that concern. Moreover, use of a shop-vac affects tool portability because the shop-vac must be transported with the power tool. Beyond all that, shop-vac use involves connecting the shop-vac(s) to electric power via suitable extension cord(s) and powering on the shop-vac at the right time when it is needed. Thus, a need exists for a better way to collect dust from a dust-producing power tool of the type described.

### SUMMARY OF THE INVENTION

In view of the foregoing, it is an object of the present invention to provide a dust-collecting arrangement for power tools of the type described that overcomes the above concerns. The present invention achieves this objective by providing a dust-collecting assembly in the form of what may be called a motorized dust bag. The dust-collecting assembly is a powered device that fits on an existing dust port of a power tool in place of the usual dust bag accessory, and it is supported by the dust port of the power tool without requiring other support. Once mounted on the dust port of the power tool and powered up, the assembly sucks sawdust and other dust from the dust port, collecting it in an attached dust bag assembly for convenient removal when desired.

Thus, the dust-collecting assembly of the present invention avoids the time and inconvenience of connecting a shop-vac to the power tool. It avoids the space requirements of a typical shop-vac. Less electric power is required. Power-tool portability is not affected. Emptying the smaller bag assembly is less work.

To paraphrase some of the more precise language appearing in the claims and further introduce the nomenclature used, a motorized dust bag assembly constructed according to the invention for connection to a dust port of a power tool includes a first element in the form of an airflow-producing subassembly. It sucks dust from the dust port. It has an air-and-dust input port (i.e., an input port through which air and dust flow) and a dust output port (i.e., an output port through which dust passes), and it is adapted to suck dust into the air-and-dust input port and release the dust through the dust output port.

The motorized dust bag assembly also includes a second element in the form of a coupling component for coupling the air-and-dust input port of the airflow-producing subassembly to the dust port of the power tool. In addition, a third element is provided in the form of a bag subassembly for collecting dust from the dust output port of the airflow-producing subassembly (i.e., receiving dust as it passes through the dust output port). The bag subassembly is connected to the dust output port.

According to the major aspect of the invention, the coupling component, the airflow-producing subassembly, and the bag subassembly form a combination of components (i.e., a motorized dust bag with some vacuum-cleaner-like functionality) that is adapted to be physically supported by the dust port of the power tool without other support when the coupling component is connected to the dust port. The dust port supports the coupling component, the coupling component supports the airflow-producing subassembly, and the airflow-producing subassembly supports the bag subassembly. Additional support for the motorized dust bag is not required.

One embodiment of the invention includes a secondary input portion of the coupling component for coupling to a region beneath the power tool in order to suck dust from beneath the power tool. A power cord is provided for coupling electrical power to the airflow-producing subassembly, and a zipper is included on the bag subassembly for enabling a user to empty collected dust when desired.

Thus, the invention overcomes some prior art dust-collecting concerns with a small, lightweight, motorized dust bag that replaces the usual shop-vac or dust-bag accessory of the prior art while requiring no modification to the existing power tool. The following illustrative drawings and detailed description make the foregoing and other objects, features, and advantages of the invention more apparent.

### BRIEF DESCRIPTION OF THE DRAWINGS

FIG. 1 of the drawings is a perspective view of a first embodiment of a motorized dust bag assembly constructed according to the invention, shown connected to an existing chop saw form of power tool that is illustrated in phantom lines;

FIG. 2 is a diagrammatic representation that represents a side elevation view of the first embodiment connected to the power tool; and

FIG. 3 is a perspective view of a second embodiment having a different coupling component with a secondary input portion for capturing sawdust from beneath the power tool.

### DESCRIPTION OF THE PREFERRED EMBODIMENTS

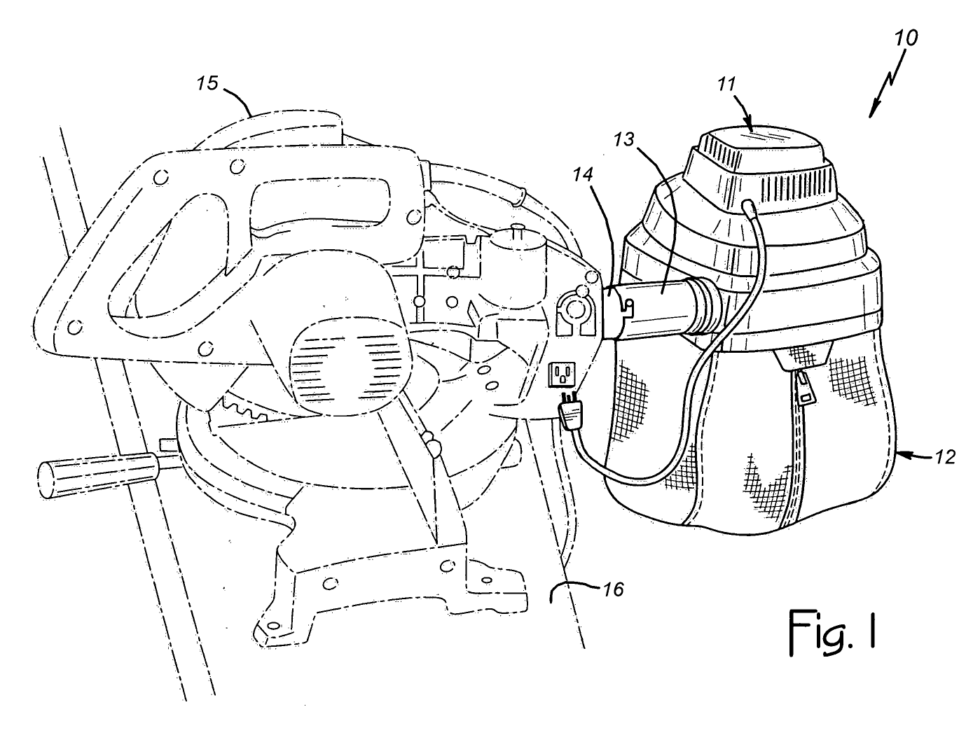

FIG. 1 of the drawings shows a power tool dust-collecting assembly constructed according to the invention in the form of a motorized dust bag assembly 10. Generally, the assembly 10 includes an airflow-producing subassembly 11, a bag subassembly 12, and a coupling component 13. Those parts are connected together to form a combination of components (i.e., the motorized dust bag assembly 10) such that the assembly 10 is adapted to be connected to a dust port 14 on a power tool 15 and to be physically supported by the dust port 14 without resting upon a support surface 16 of a table, bench, or other supportive structure.

As such, the assembly 10 can be connected to and supported by the dust port 14 in place of a commonly used dust bag accessory (not shown) of the type existing in the prior art. So connected and supported, the assembly 10 more effectively captures sawdust and/or other dust produced by the power tool 12 without otherwise affecting operation or portability of the power tool 12, and without introducing the various drawbacks of using a shop-vac connected to the dust port 11.

The power tool 15 represents any of various types of tools, including chop saws, miter saws, and the like, that include a dust port (see, for example, the compound miter saw 10 shown in U.S. Pat. No. 6,431,040 B1). The dust port 14 represents a typical dust port on such a power tool, with such a typical dust port taking the form of a cylindrically shaped tube having an outside diameter of about 1.0 inches to about 1.5 inches or so (e.g., the dust duct 33 shown in U.S. Pat. No. 6,431,040 B1). Many commercially available power tools include a dust bag accessory that slips onto such a dust port (e.g., the dust collection bag accessory 63 shown in U.S. Pat. No. 6,431,040 B1). The coupling component 13 of the motorized dust bag assembly 10 slips onto the dust port 14 in place of such a prior art dust bag accessory.

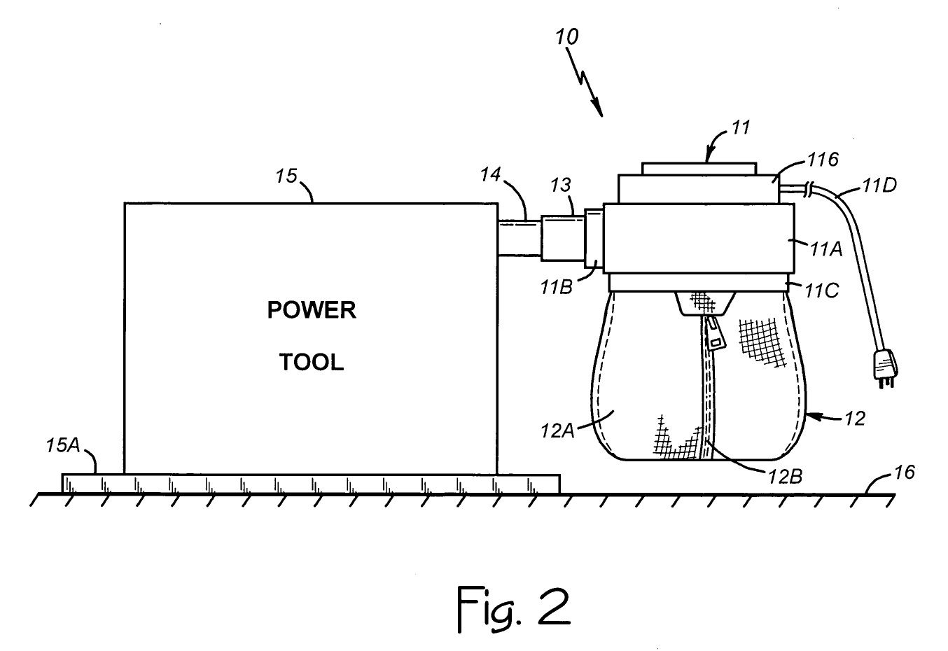

As shown diagrammatically in FIG. 2, the airflow-producing subassembly 11 includes a housing 11A composed of a rigid material (e.g., metal or plastic) that has an air-and-dust input port 11B and a dust output port 11C. The airflow-producing subassembly 11 produces an airflow (i.e., a flow of air) that flows into the input port 11B while carrying along dust from the dust port 14 of the power tool 15. The dust is released within the housing 11A, passing through the dust output port 11C into an upwardly opening bag subassembly 12 that is connected to the dust output port 11C. Thus, the airflow-producing subassembly 11 functions similar to the suction-producing device of a vacuum cleaner (i.e., a device that uses an air pump to create a partial vacuum to suck up dust and dirt).

The airflow-producing subassembly 11 has an electrically powered motor (not shown) that is supplied with electrical power via a power cord 11D and a suitable On/Off switch (not shown). The electrically powered motor provides rotational energy to an impeller component (not shown) that rotates within an impeller enclosure 11E to produce the airflow. The motor and impeller may take the form of well-known components. In terms of the claim language, the airflow-producing subassembly 11 is adapted to suck dust and air into the air-and-dust input port 11B and release the dust through the dust output port 11C. It is adapted to do so in the sense that it includes the components necessary to function as stated. Based upon the foregoing and subsequent descriptions, one of ordinary skill in the art can readily implement an airflow-producing subassembly 11 as part of a motorized dust bag assembly constructed according to the invention.

The bag subassembly 12 serves as means for collecting dust from the dust output port 11C. It includes an upwardly opening flexible bag 12A (e.g., composed of fabric material) having a zipper 12B that provides access to the interior for purposes of emptying dust from the bag 12A when desired. The bag subassembly 12 is connected to the dust output port 11C by suitable means so that dust released through the dust output port 11C collects within the bag 12A.

The coupling component 13 is composed of a rigid material (e.g., plastic or metal). It is connected to the air-and-dust input port 11B by suitable means and it is adapted to fit on the dust port 14 of the power tool 15 in place of a prior art dust bag accessory. It couples the dust port 14 and the air-and-dust input port 11B in fluid communication so that the airflow-producing subassembly 11 can suck air and dust from the dust port 14. It is adapted to fit on the dust port 14 in the sense that the coupling component 13 is suitably sized and shaped to mate with the size and shape of the dust port 14.

With the coupling component 13 connected to the dust port 14, the dust port 14 portion of the power tool 15 supports the coupling component 13, the coupling component 13 supports the airflow-producing subassembly 11 and the airflow-producing subassembly 11 supports the bag subassembly 12. Additional support for the motorized dust bag 10 is not required. The bag 12A need not contact the support surface 16 or a base portion 15A of the power tool 15 for support. In terms of the claim language, the coupling component 13 combines with the airflow-producing subassembly 11 and the bag subassembly 13 to form a combination of components that is adapted to be physically supported by the dust port 14 of the power tool 15 without other support when the coupling component 13 is connected to the dust port 14. It is so adapted in the sense that it is suitably sized to be so supported.

As a further idea of size, the weight of a motorized dust bag assembly constructed according to the invention falls within a range of about 1.0 pounds to about 6.0 pounds, with the illustrated assembly 10 weighing about 3.0 pounds. The overall height of a motorized dust bag assembly constructed according to the invention falls within a range of about 6.0 inches to about 18.0 inches, with the illustrated assembly 10 having an overall height of about 12.0 inches, depending in large part on the height of the dust port on the particular power tool of interest. In operation, the airflow-producing subassembly draws in the range of about 2.0 amperes to about 8.0 amperes, with the illustrated assembly 10 drawing about 5.0 amperes. Of course, the precise values may vary significantly according to the particulars of the power tool and the characteristics designed into the motorized dust bag assembly.

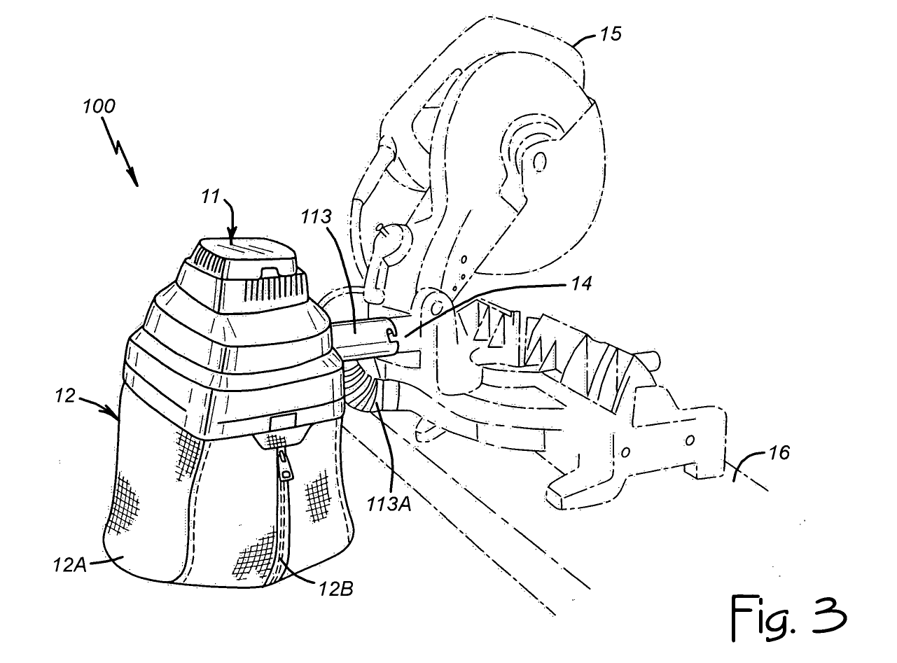

Turning now to FIG. 3, it shows a second embodiment of the invention in the form of a motorized dust bag assembly 100. The assembly 100 is similar in many respects to the assembly 10 and so only differences are described in more detail. The major difference is that the assembly 100 includes a coupler component 113 having a secondary input portion 113A. The coupler component 113 is otherwise similar to the coupler component 13. The secondary input portion 113A serves as means for sucking dust from beneath the power tool 15 for even greater dust-collecting action.

Thus, the invention overcomes some prior art dust-collecting concerns with a small, lightweight, motorized dust bag assembly that replaces the usual shop-vac or dust-bag accessory of the prior art while requiring no modification to the existing power tool. The motorized dust bag assembly avoids the time and inconvenience of connecting a shop-vac to the power tool. It avoids the space requirements of a typical shop-vac. Less electric power is required. Power-tool portability is not affected. Emptying the smaller bag assembly is less work. Although exemplary embodiments have been shown and described, one of ordinary skill in the art may make many changes, modifications, and substitutions without necessarily departing from the spirit and scope of the invention. As for the specific terminology used to describe the exemplary embodiments, it is not intended to limit the invention; each specific term is intended to include all technical equivalents that operate in a similar manner to accomplish a similar purpose or function.

What is claimed is:

1. An assembly for collecting dust from a dust port of a power tool, the assembly comprising:
means for sucking dust from the dust port, including an airflow-producing subassembly having an air-and-dust input port and a dust output port, which airflow-producing subassembly is adapted to suck dust and air into the air-and-dust input port and release the dust through the dust output port;
means for coupling the air-and-dust input port of the airflow-producing subassembly to the dust port of the power tool, including a coupling component connected to the air-and-dust input port of the airflow-producing subassembly; and
means for collecting dust from the dust output port of the airflow-producing subassembly, including a bag subassembly connected to the dust output port;
wherein the coupling component, the airflow-producing subassembly, and the bag subassembly form a combination of components that is adapted to be physically supported by the dust port of the power tool without other support when the coupling component is connected to the dust port of the power tool.

2. An assembly as recited in claim 1, further comprising means for sucking dust from beneath the power tool, including a secondary input portion of the coupling component for coupling to a region beneath the power tool.

3. An assembly as recited in claim 1, wherein the coupling component includes a rigid member adapted to slip onto the dust port of the power tool.

4. An assembly as recited in claim 1, wherein the bag subassembly includes a zipper for enabling a user to empty dust from the bag assembly.

5. An assembly as recited in claim 1, wherein the bag subassembly is at least partially composed of a flexible fabric material.

6. An assembly as recited in claim 1, further comprising a power cord for coupling electrical power to the vacuum-generating subassembly.
